(19) United States
(12) Patent Application Publication
(10) Pub. No.: US 2012/0255519 A1
(43) Pub. Date: Oct. 11, 2012

(54) Fuel treatment method

(76) Inventor: Claude L. Hebert, Boucherville (CA)

(21) Appl. No.: 13/506,218

(22) Filed: Apr. 4, 2012

(30) Foreign Application Priority Data
Apr. 5, 2011 (CA) 2,736,337

(51) Int. Cl. F02M 27/04; B23P 17/04

(52) U.S. Cl. 123/434; 137/15.01

(57) ABSTRACT

There is provided a device and a method for decreasing hydrocarbon fuel usage in a vehicle, the method including the steps of installing a fuel treatment device whereby fuel passes through the device prior to going to the engine, the fuel treatment device having an inlet and an outlet, an inner tube having at least one magnet pair with a north pole and a south pole, and an outer tube concentric with the inner tube to thereby form a passageway between the inner tube and the outer tube, a baffle member being mounted in the passageway to cause fuel passing therethrough to flow in a spiral configuration.

### FIELD OF THE INVENTION

The present invention relates to a magnetic treatment device and a method for treating fuels.

### BACKGROUND OF THE INVENTION

Devices and methods for the treatment of a fuel have been proposed for many years. Thus, reference may be had to U.S. Pat. No. 5,585,765 to Twardzik which teaches that when a magnetic force is applied across the path of a flowing hydrocarbon fuel, the hydrocarbon molecules tend to align with the direction of a magnetic field. As the access of the electrons in the hydrocarbon molecules become aligned with the external magnetic field, the angular momentum of the molecule no longer averages out to zero as is the normal case in molecules not possessing permanent dipole properties. The Patentee teaches that the fluctuating dipole moments under the influence of the external magnetic field acquire a net attractive force which produces a stronger bonding with oxygen ions. As a result, the complex fuel molecules tend to uncloister, straighten and produce higher combustion efficiencies.

There are a myriad of other patents and proposed devices and systems to treat hydrocarbon fuels with magnetics. However, none of these devices, to the best of Applicant's knowledge, has gained commercial acceptance and indeed, many experts doubt that such devices do increase fuel efficiency.

### SUMMARY OF THE INVENTION

It is an object of the present invention to provide a device and method for treating hydrocarbon fuels to increase the fuel efficiency of the vehicle using the fuel.

According to one aspect of the present invention, there is provided a method of decreasing hydrocarbon fuel usage in a vehicle comprising the steps of installing a fuel treatment device on the vehicle such that fuel passes through the device prior to being sent to the engine, the fuel treatment device comprising an inlet and an outlet, an inner tube, the inner tube having at least one magnet pair having a north pole and a south pole therein, an outer tube concentric with the inner tube to thereby form a passageway between the inner tube and the outer tube, a baffle member mounted in the passageway, the baffle member causing fuel passing therethrough to flow in a spiral configuration.

According to a further aspect of the present invention, there is also provided in a vehicle having an internal combustion engine, the improvement wherein the vehicle includes a fuel treatment device mounted such that fuel passes therethrough prior to being sent to the internal combustion engine, the fuel treatment device comprising, an inlet and an outlet, an inner tube, the inner tube having at least one magnet pair therein, an outer tube concentric with the inner tube to form a passageway therebetween, and a baffle mounted in the passageway, the baffle causing fuel passing therethrough to flow in a spiral configuration.

The fuel utilized in the vehicle undergoes a magnetic conditioning or treatment prior to entering into the engine. The magnetic conditioning or treatment consists in providing a magnetic field having magnetic lines of flux at a desired density. The means for providing the magnetic field are well known to those skilled in the art and thus, permanent magnets may conveniently be utilized. A shielding is provided to prevent the magnetic fields from disrupting any instrumentation.

Various parameters in the application of the magnetic field can be varied. For example, one may consider the number of magnetic fields generated, the flux density, the total magnetic flux lines, the flow rate of the fuel, and the angle at which the direction of the flow of the field cuts the magnetic lines of flux.

Generally, the flux density may range between 1,200 gaus and 1,500 gaus although this may be increased or decreased depending upon other operational parameters. The total number of magnetic lines of flux desirably will range between 4,000 to 20,000 although again, this may be varied depending upon the other parameters. Ideally, the intersection of the direction of flow of the fuel and the direction of magnetic flux lines would 90°. Since this is often unachievable considering other operational parameters, it becomes desirable to at least have a relatively large angle (greater than)60° between the directions of the fuel flow and magnetic lines of flux.

The fuel may be exposed to a single magnetic field or in the alternative, may be exposed to a plurality of the magnetic fields. In the preferred embodiments, the fuel will pass through at least two magnetic fields.

One parameter which needs to be considered is the direction of flow through the magnetic field. Preferably, the fuel will enter the treatment zone at a north polarity portion and exit at a south polarity direction.

According to one aspect of the present invention, there is provided a method of increasing fuel economy for a vehicle using a hydrocarbon fuel, a method comprising the step of subjecting the hydrocarbon fuel to a magnetic field in a direction to cut lines of flux therefrom such that the direction of fuel flow and the direction of the flux lines intersect at an angle.

There is also provided a device for treating hydrocarbon fuel, the device comprising a central cylinder having means for creating a magnetic field, and an outer cylinder defining a fluid passageway, and a plurality of spirally extending members about the inner cylinder to force the fuel to pass in a spiral direction.

### BRIEF DESCRIPTION OF THE DRAWINGS

Having thus generally described the invention, reference will be made to the accompanying drawings illustrating an embodiment thereof, in which:

FIG. 1 is a side elevational view, partially in section, of an apparatus according to the present invention; and

FIG. 2 is a cross sectional view thereof.

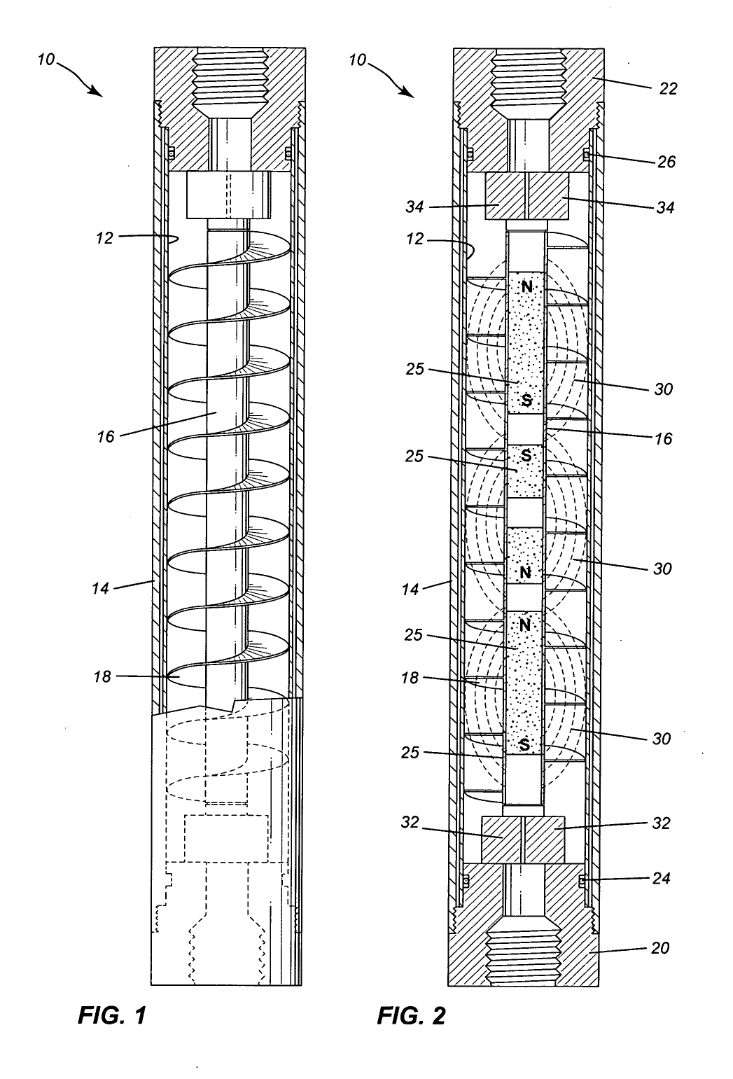

### DETAILED DESCRIPTION OF THE INVENTION

Referring to the drawings in greater detail and by reference characters thereto, an apparatus of the present invention is illustrated and generally designated by reference numeral 10.

Apparatus 10 includes an outer cylinder 12 preferably formed of a stainless steel tubing. Surrounding outer cylinder 12 is a magnetic shield 14 formed of any suitable material such as a suitable metallic sheeting.

An inner cylinder, also preferably of stainless tubing is designated by reference numeral 16 with a plurality of spirals 18 extending thereabout. A fluid passageway is defined between outer cylinder 12 and inner cylinder 16 such that any liquid passing therethrough is imparted in a spiral motion.

Mounted within inner cylinder 16 are means for creating a magnetic field and in the illustrated embodiment, comprise a plurality of permanent magnets 25 with their respective poles being designated by reference numerals N and S. Lines of flux 30 are illustrated in dashed lines in FIG. 2.

At either end of cylinders 12 and 16, there are provided adaptors 20 and 22 each having O rings 24 and 26 associated therewith. Stainless steel spacers 32 and 34 are provided at the end of inner cylinder 16.

In use, the hydrocarbon fuel is passed into the space between inner cylinder 16 and outer cylinder 12 such that the fuel will move in a spiral motion due to spirals 18. In so doing, the fuel is subjected to a magnetic field in a direction so as to cut lines of flux at an angle thereto.

Different types of hydrocarbon fuels may be utilized including, for example, diesel, gasoline, et cetera.

Example 1: a test was run including a control vehicle. Two autobuses were utilized in an urban circuit with partial inter-city service. After adjusting for variables, the vehicle using the magnetic treatment device utilized an average of 3.53 percent less fuel.

It will be understood that the above described embodiment is for purposes of illustration only and that changes and modifications may be made thereto without departing from the spirit and scope of the invention.

I claim:

1. A method of decreasing hydrocarbon fuel usage in a vehicle comprising the steps of:
installing a fuel treatment device on said vehicle such that fuel passes through said device prior to being sent to said engine;
said fuel treatment device comprising an inlet and an outlet;
an inner tube, said inner tube having at least one magnet pair having a north pole and a south pole therein;
an outer tube concentric with said inner tube to thereby form a passageway between said inner tube and said outer tube, a baffle member mounted in said passageway, said baffle member causing fuel passing therethrough to flow in a spiral configuration.

2. The method of claim 1 wherein said fuel treatment device is installed such that magnetic lines of flux from said magnet and the flow of fuel through said passageway is such that the direction of flux lines interacts at an angle.

3. The method of claim 2 wherein the angle between said lines of flux and a fuel flow direction is greater than 60°.

4. The method of claim 3 wherein said vehicle utilizes diesel fuel.

5. The method of claim 3 wherein said vehicle utilizes gasoline as a fuel.

6. In a vehicle having an internal combustion engine, the improvement wherein said vehicle includes a fuel treatment device mounted such that fuel passes therethrough prior to being sent to said internal combustion engine, said fuel treatment device comprising:
an inlet and an outlet;
an inner tube, said inner tube having at least one magnet pair therein;
an outer tube concentric with said inner tube to form a passageway therebetween; and
a baffle mounted in said passageway, said baffle causing fuel passing therethrough to flow in a spiral configuration.

7. The improvement of claim 6 wherein said internal combustion engine utilizes gasoline.

8. The improvement of claim 6 wherein said vehicle utilizes a diesel fuel.

9. The improvement of claim 6 wherein said fuel treatment device is installed such that magnetic lines of flux from said magnet and the flow of fuel through said passageway is such that the direction of flux lines interacts at an angle.

10. The improvement of claim 9 wherein the angle between said lines of flux and a fuel flow direction is greater than 60°.
